(19) United States
(12) Patent Application Publication
(10) Pub. No.: US 2017/0228462 A1
(43) Pub. Date: Aug. 10, 2017

(54) ADAPTIVE SEEDED USER LABELING FOR IDENTIFYING TARGETED CONTENT

(71) Applicant: Microsoft Technology Licensing, LLC, Redmond, WA (US)

(72) Inventors: Jason Z. Zhu, Redmond, WA (US); Shaoyu Zhou, Issaquah, WA (US); Kailun Hu, Bellevue, WA (US); Yaowen Zhan, Sammamish, WA (US); Wen Ding, Bellevue, WA (US); James Sijian Zhang, Bellevue, WA (US)

(21) Appl. No.: 15/016,193

(22) Filed: Feb. 4, 2016

(51) Int. Cl. G06F 17/30; G06Q 30/02; H04L 29/08

(52) U.S. Cl. CPC G06F 17/30867; H04L 67/02; G06Q 30/0251

(57) ABSTRACT

Examples of the disclosure enable generating, maintaining, and/or updating a model configured to identify content for a segment. In some examples, a plurality of keywords associated with accessing webpages are retrieved. A plurality of keyword scores corresponding to the keywords are generated. Based on the keyword scores, a subset of keywords are identified as being associated with the segment. The subset of keywords are compared with content keywords associated with content to determine whether to include the content in a subset of content associated with the segment. Users associated with the subset of content are identified. Based on metrics associated with the users, the users are labeled for generating a training set associated with the segment. Aspects of the disclosure enable a predictive model to be generated, maintained, and/or updated in a calculated and systematic manner for increased performance.

### BACKGROUND

Content providers spend billions of dollars each year on serving content to users. Online content may be served, for example, at one or more user devices that present the content to the users. To serve content that is relevant to users, at least some content providers manually analyze data to identify targeted content. In some examples, a user may be manually classified into one or more predefined segments to facilitate identifying targeted content for the user. With the rapid growth of online content and the evolving nature of the content, it may be tedious, time consuming, and/or costly to identify targeted content for at least some segments and/or to classify users into at least some segments using known methods and systems.

### SUMMARY

Examples of the disclosure enable generating, maintaining, and/or updating a machine learning model configured to identify targeted content for a segment in an efficient and effective manner. In some examples, a plurality of search query keywords associated with accessing one or more webpages are retrieved. The webpages are associated with a segment. A plurality of keyword scores corresponding to the search query keywords are generated. The keyword scores are indicative of a correlation between the search query keywords and the webpages associated with the segment. Based on the keyword scores, a subset of search query keywords are selected from the plurality of search query keywords. The subset of search query keywords is identified as being associated with the segment and are compared with one or more content keywords associated with a content to determine whether to include the content in a subset of content associated with the segment. One or more users associated with the subset of content are identified. The users are associated with one or more metrics. Based on the metrics, the users are labeled for generating a training set associated with the segment.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of an example environment for serving content.

FIG. 2 is a block diagram of an example system for identifying targeted content in an environment, such as the environment shown in FIG. 1.

FIG. 3 is a block diagram of an example server environment for generating, maintaining, or updating a machine learning model configured to identify targeted content.

FIG. 4 is a flowchart of an example method for generating, maintaining, or updating a machine learning model in a computing environment, such as the server environment shown in FIG. 3.

FIG. 5 is a flowchart of an example method for identifying a set of search query keywords associated with a segment.

FIG. 6 is a flowchart of an example method for identifying a subset of content associated with a segment.

FIG. 7 is a flowchart of an example method for generating seeded users for generating, maintaining, or updating a machine learning model associated with a segment.

FIG. 8 is a block diagram of an example computing device that may be used in an environment, such as the environment shown in FIG. 1.

Corresponding reference characters indicate corresponding parts throughout the drawings.

### DETAILED DESCRIPTION

The subject matter described herein is related generally to providing online content and, more particularly, to generating, maintaining, and/or updating a machine learning model for identifying content that is relevant to a user associated with a segment. For example, one or more webpages associated with a segment may be identified, and a plurality of search query keywords used to identify and/or access the identified webpages are retrieved. A keyword score is computed for each search query keyword, and, based on the computed keyword scores, a subset of search query keywords are identified as being associated with the segment. The subset of search query keywords are compared with one or more content keywords associated with a plurality of content to identify a subset of content associated with the segment. One or more users associated with the subset of content are automatically labeled to seed a predictive model so that content that is relevant to the segment may be identified based on the labeled users. As used herein, the term “seed” and “seeded” refer to information that may be used to generate, maintain, and/or update an entity (e.g., a model for identifying targeted content).

Subject matter associated with at least some content (e.g., news, sports, music, technology) changes over time. Moreover, tastes and preferences of at least some users also change over time. The examples described herein enable targeted content to be identified in an efficient and effective manner. For example, the examples described herein identify changes in content and/or changes in user behavior (e.g., preferences, actions) and automatically generate, maintain, and/or update a machine learning model based on the changes to identify current, relevant content. The examples described herein may be implemented using computer programming or engineering techniques including computing software, firmware, hardware, or a combination or subset thereof. Aspects of the disclosure enable a predictive model to be generated, maintained, and/or updated in a calculated and systematic manner for increased performance.

The examples described herein manage one or more operations or computations associated with serving content. By serving content in the manner described in this disclosure, some examples reduce processing load, conserve memory, and/or reduce network bandwidth usage by systematically distinguishing current, relevant data from less-relevant data. For example, efficiently identifying current, relevant data enables at least some system resources (e.g., processor, memory, network bandwidth) to be strategically allocated to the processing, storing, and/or transmitting of current, relevant data and, in some instances, preserved. Additionally, some examples may improve operating system resource allocation and/or improve communication between computing devices by streamlining at least some operations, improve user efficiency and/or user interaction performance via user interface interaction, and/or reduce error rate by automating at least some operations.

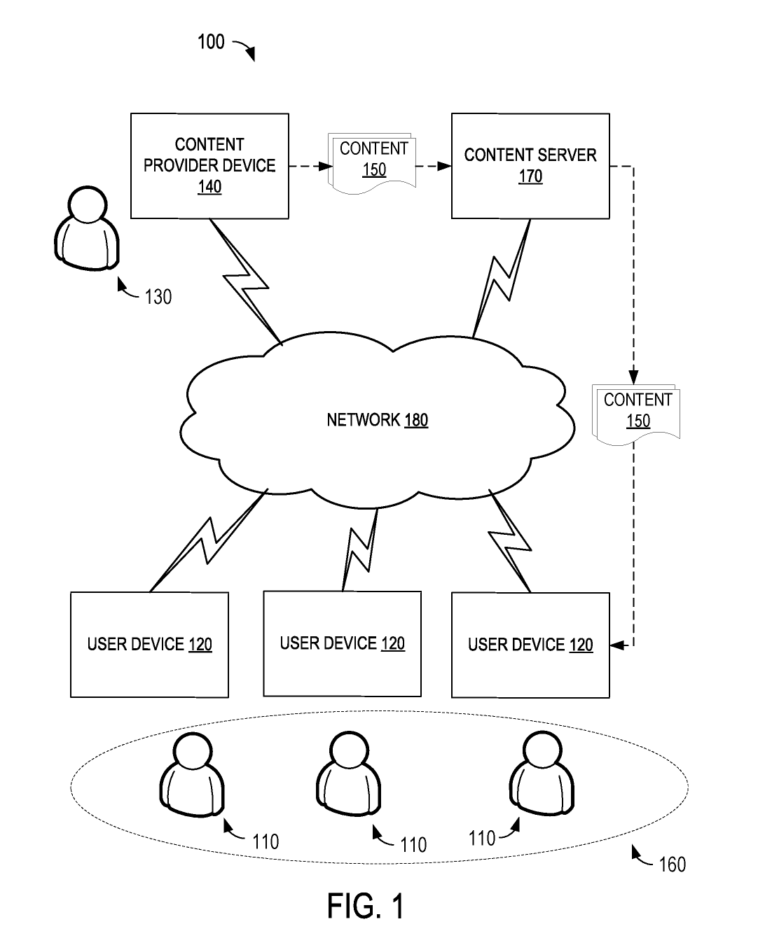

FIG. 1 is a block diagram of an example environment 100 that may be used to present content to one or more users 110 (e.g., a consumer) at one or more user devices 120. In the environment 100, a content provider 130 (e.g., an advertiser) may use one or more content provider devices 140 to generate a plurality of content 150 (e.g., an advertisement) and provide the content 150 for presentation at the user device 120.

The users 110 may be classified in one or more segments 160. Each segment 160 includes one or more users 110 that are associated with the same or similar characteristics (e.g., behavioral, demographic, psychographic, geographical). For example, a pop music segment 160 may include one or more users 110 that are responsive to information associated with pop music (e.g., bands, musicians, singing competitions), and a mobile device segment 160 may include one or more users 110 that are responsive to information associated with mobile devices (e.g., tablets, smartphones). A user 110 may be classified in any quantity of segments 160 including zero. Even though the environment 100 relates to an Internet advertising scenario, it should be noted that the present disclosure applies to various other environments in which information (e.g., content 150, media) is presented to the user 110.

The environment 100 includes one or more content servers 170 configured to receive content 150 from the content provider device 140 and/or transmit the content 150 to the user device 120. In some examples, the content servers 170 is coupled to the content provider device 140 and/or the user device 120 via one or more networks 180. Example networks 180 include a personal area network (PAN), a local area network (LAN), a wide area network (WAN), a cellular or mobile network, and the Internet. Alternatively, the network 180 may be any communication medium that enables a first computing device (e.g., content servers 170) to communicate with a second computing device (e.g., user device 120, content provider device 140). In some examples, at least some of the content 150 may be stored at the content servers 170.

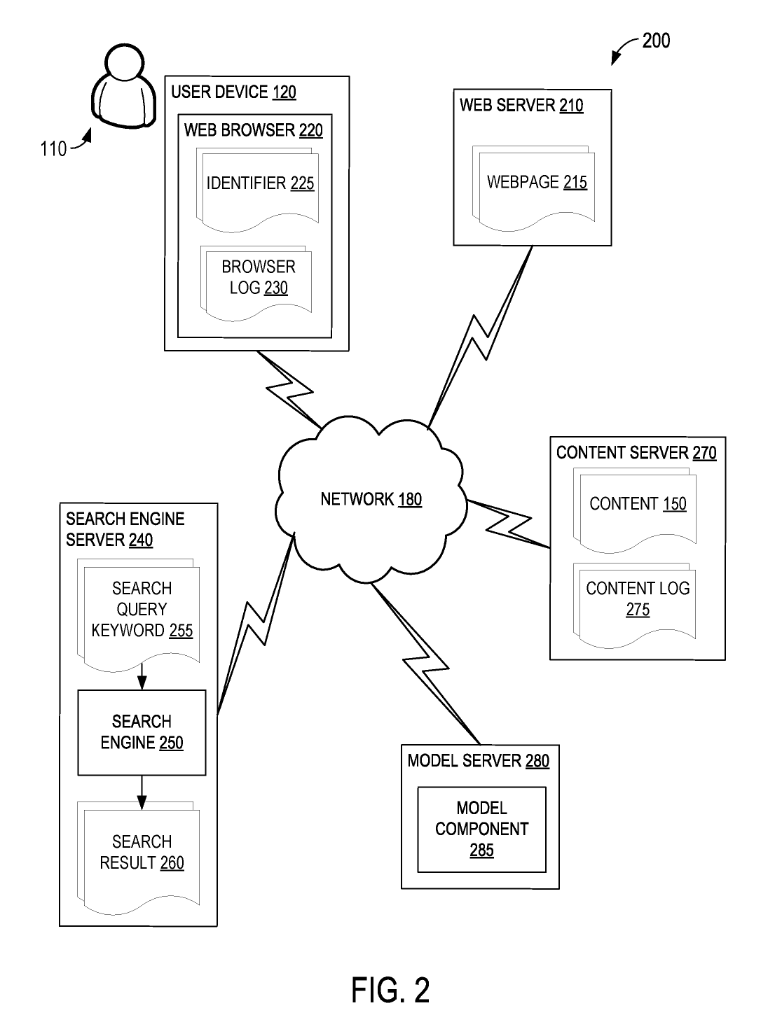

FIG. 2 is a block diagram of an example system 200 that may be used to present targeted content to a user 110 in the environment 100 (shown in FIG. 1). The system 200 includes one or more web servers 210 configured to store and/or provide one or more webpages 215. The webpage 215 may be accessible to another computing device (e.g., user device 120) via a network 180. For example, a user device 120 may use a web browser 220 to access or retrieve the webpage 215 from the web server 210 by submitting a request for information identified by an identifier 225 (e.g., Universal Resource Identifier or URI) that corresponds to the webpage 215 using a transfer protocol (e.g., Hypertext Transfer Protocol or HTTP). The identifier 225 may include, for example, a Uniform Resource Locator (URL) and/or a Uniform Resource Name (URN). In response to the receiving the request, the web server 210 may transmit the webpage 215 to the user device 120 for presentation at the user device 120.

In some examples, the web browser 220 is configured to generate one or more browser logs 230 that include information associated with a webpage 215 retrieved by the web browser 220. Browser log information may include, for example, an identifier 225, a webpage title, a browser command (e.g., the request for information), a time stamp associated with the browser command, user information associated with the user 110 and/or the user device 120 (e.g., client address, unique identifier), and/or user interface information (e.g., boxes or radio buttons selected, buttons pressed, characters entered into a text field).

In some examples, the user device 120 may communicate with one or more search engine servers 240 (e.g., via the network 180) that include or are associated with a search engine 250 to locate one or more objects (e.g., webpages 215). For example, the user device 120 may transmit one or more search queries to the search engine server 240. The search query may include one or more search query keywords 255 and/or operators that correspond to a request for information. The search engine 250 processes the search query keywords 255 and/or operations to locate one or more webpages 215 and generate one or more search results 260 based on the located webpages 215 in accordance with the search query keywords 255 and/or operations. For example, the search results 260 may include one or more identifiers 225 that correspond to the located webpages 215. In some examples, the search engine 250 may be associated with a web server 210 and be configured to locate one or more objects on a webpage 215 stored at and/or associated with the web server 210.

Upon generating the search results 260, the search engine server 240 transmits the search results 260 to the user device 120. In some examples, the search results 260 are presented at the user device 120 as a first webpage 215 including one or more hyperlinks configured to allow the user device 120 to communicate with one or more web servers 210 corresponding to one or more second webpages 215 (e.g., located webpage 215) to retrieve the second webpages 215.

The system 200 includes one or more content servers 270 (e.g., content server 170) configured to provide one or more content 150 for presentation at the user device 120. In some examples, the content server 270 generates one or more content logs 275 that include information associated with content 150 served to one or more user devices 120. Content log information may include, for example, a quantity of requests received, a quantity of impressions, a quantity of clicks, a quantity of conversions, a clickthrough rate, a conversion rate, a time stamp, an identifier 225 associated with a webpage 215 at which content 150 is presented, user information associated with the user 110 and/or the user device 120 at which content 150 is presented. As described herein, the term “impression” refers a presentation of content 150 at a user device 120, the term “click” refers to a user interaction with the content 150 at the user device 120, and the term “conversion” refers to a predetermined desired user action (e.g., purchase, subscription). Moreover, the term “clickthrough rate” refers to a percentage of impressions that resulted in a click, and the term “conversion rate” refers to a percentage of clicks that results in the predetermined desired user action.

The system 200 includes a model server 280 configured to select and/or identify a subset of content 150 targeted to a user 110. The model server 280 may include, for example, a model component 285 configured to maintain and/or update one or more segment definitions to enable the model server 280 to automatically select and/or identify the targeted content 150 from a plurality of content 150. In some examples, the model server 280 is configured to communicate with the content server 270 (e.g., via the network 180) to identify the targeted content 150, and transmit the targeted content 150 to the user device 120 for presentation to the user 110 at the user device 120.

For example, the model server 280 may be configured to identify a webpage 215 for presentation at the user device 120 and, based on the identified webpage 215, select content 150 for presentation at the user device 120 with the webpage 215. The content 150 may be selected based on one or more predetermined factors, including a subject matter associated with the webpage 215, a subject matter associated with the content 150, a priority associated with the content 150, a priority associated with a content provider (e.g., content provider 130) corresponding to the content 150, a geographic location associated with the user 110, a geographic location associated with the user device 120, and/or a past behavior associated with the user 110.

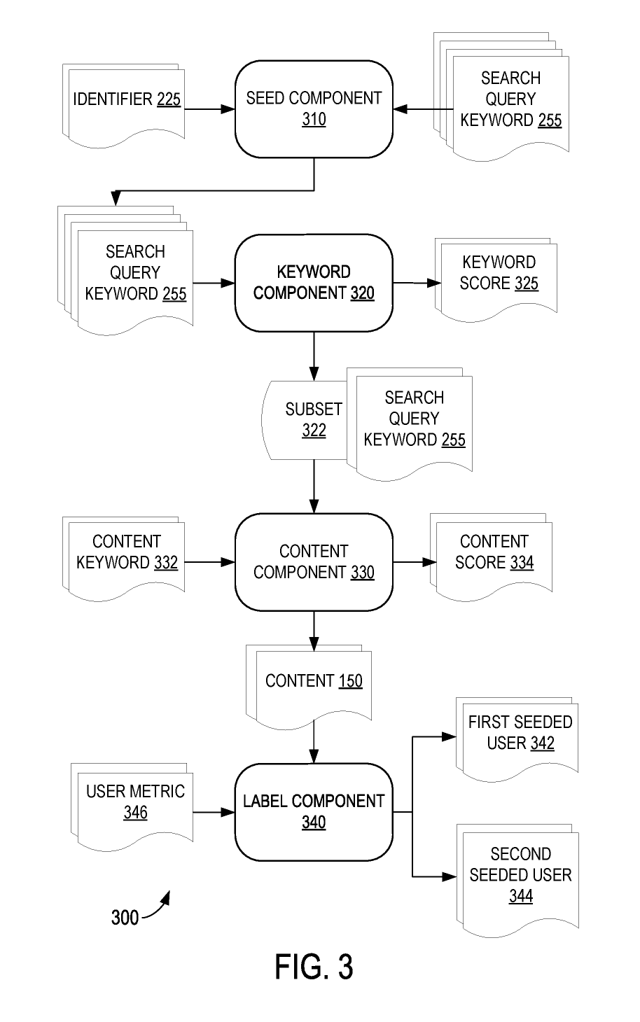

FIG. 3 is a block diagram of an example server environment 300 that may be used to generate, maintain, and/or update a model component 285 (shown in FIG. 2) for maintaining and/or updating one or more segment definitions in the environment 100 (shown in FIG. 1). The server environment 300 may be associated with one or more servers (e.g., model server 280) configured to select and/or identify targeted content 150 for a user 110 associated with a segment 160. Segment definitions at least partially define the segment 160 and, thus, may be used to select and/or identify the targeted content 150.

To enable the server environment 300 to generate, maintain, and/or update a model component 285 for a segment 160, a seed component 310 receives seeded information that potentially defines the segment 160. The seeded information may include, for example, a list of seeded identifiers 225 that correspond to one or more webpages 215 associated with the segment 160. Based on the seeded information, the seed component 310 retrieves one or more search query keywords 255 associated with accessing the webpages 215 that correspond to the seeded identifiers 225. The search query keywords 255 may have been used, for example, to generate one or more search results 260 that allowed the user 110 to retrieve a webpage 215 associated with the segment 160.

In some examples, the seed component 310 communicates with the user device 120 (e.g., via the network 180) to access one or more browser logs 230 at the user device 120 and, from the browser logs 230, extract or identify a plurality of search query keywords 255 that led or enabled the user 110 to access the webpages 215 that correspond to the seeded identifiers 225. Additionally or alternatively, the seed component 310 may communicate with the search engine server 240 (e.g., via the network 180) to access one or more search queries at the search engine server 240 and, from the search queries, extract or identify a plurality of search query keywords 255 that led or enabled one or more users 110 to access the webpages 215 that correspond to the seeded identifiers 225.

Based on the plurality of search query keywords 255, a keyword component 320 generates or computes a plurality of keyword scores 325 that correspond to the search query keywords 255 (e.g., {keyword1, score1), (keyword2, score2), . . . }). In some examples, the keyword component 320 computes the keyword scores 325 based on a correlation between the search query keywords 255 and the webpages 215. For example, a keyword score 325 may be computed for each search query keyword 255 based on a frequency of the search query keyword 255 leading or enabling the user 110 to access a webpage 215 that corresponds to a seeded identifier 225. One formula for computing a keyword score 325 (e.g., Score) for a search query keyword 255 (e.g., KW) based on a correlation between the search query keyword 255 and a webpage 215 associated with an identifier 225 (e.g., URI) is as follows:

$$Score ( K W , URIs ) = \frac{{\sum }_{i = 1}^{n} Count ( K W , URI ( i ) )}{{\sum }_{kw} {\sum }_{i = 1}^{n} Count ( k w , URI ( i ) )} . \qquad ( Eq . 1 )$$

Based on the computed keyword scores 325, the keyword component 320 selects or identifies, from the plurality of search query keywords 255, a subset 322 of search query keywords 255 that represent and at least partially define the segment 160. For example, the keyword scores 325 may be indicative of a correlation between the search query keywords 255 and one or more webpages 215 associated with the segment 160. In such an example, the keyword component 320 may select the search query keywords 255 associated with keyword scores 325 that are indicative of a stronger correlation with the webpages 215 associated with the segment 160.

In some examples, the keyword component 320 rank orders the search query keywords 255 by keyword score 325, and identifies a predetermined quantity of search query keywords 255 associated with the highest keyword scores 325 to represent and at least partially define the segment 160. Additionally or alternatively, the keyword component 320 may generate a first keyword score 325 associated with a first search query keyword 255 and, on condition that the first keyword score 325 satisfies a predetermined threshold, add or include the first search query keyword 255 in the subset 322 of search query keywords 255 associated with the segment. At least some operations associated with the seed component 310 and/or the keyword component 320 may be iteratively implemented, on a regular or irregular basis, such that a segment definition reflects recent trends in search query keywords 255 associated with accessing webpages 215 associated with the segment 160.

In some examples, a content component 330 retrieves a plurality of content 150 and/or content keywords 332 associated with the content 150 from the content server 270. The content component 330 selects or identifies, from the plurality of content 150, a subset of content 150 associated with the segment 160 based on the subset 322 of search query keywords 255 and one or more content keywords 332 associated with a plurality of content 150. For example, the content component 330 may compare the subset 322 of search query keywords 255, which are identified to represent the segment 160, with content keywords 332 associated with content 150 to determine whether the content 150 is relevant to the segment 160. In some examples, the content component 330 may analyze content 150 to identify one or more content keywords 332 associated with the content 150.

In some examples, the content component 330 generates or computes a plurality of content scores 334 that correspond to a plurality of content 150 (e.g., {(content1, score1), (content2, score2), . . . }). For example, a content score 334 may be computed for each content 150 based on a similarity between the subset 322 of search query keywords 255 and the content keywords 332 associated with the content 150. One formula for computing a content score 334 for content 150 is as follows:

$$similarity = cos ( Θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2} \sqrt{{\sum }_{i = 1}^{n} {B}_{i}^{2}}}} , \qquad ( Eq . 2 )$$

where Aᵢ is a search query keyword 255, and Bⱼ is a content keyword 332. Another formula for computing a content score 334 for content 150 that considers semantics is as follows:

$${soft\_cosine}_{1} ( a , b ) = \frac{{\sum }_{i , j}^{N} {s}_{ij} {a}_{i} {b}_{j}}{\sqrt{{\sum }_{i , j}^{N} {s}_{ij} {a}_{i} {a}_{j}} \sqrt{{\sum }_{i , j}^{N} {s}_{ij} {b}_{i} {b}_{j}}} , \qquad ( Eq . 3 )$$

where aᵢ is a search query keyword 255, bⱼ is a content keyword 332, and sᵢⱼ is a similarity between the search query keyword 255 and the content keyword 332.

The content component 330 may use the content scores 334 to select or identify, from the plurality of content 150, the subset of content 150 associated with the segment 160. In some examples, the content component 330 rank orders the plurality of content 150 by content score 334 and identifies a predetermined quantity of content 150 associated with the highest content scores 334 as being relevant to the segment 160. Additionally or alternatively, the content component 330 may generate a first content score 334 associated with a first content 150 based on a correlation between the set of search query keywords 255 and one or more content keywords 332 associated with the first content 150 and, on condition that the first content score 334 satisfies a predetermined threshold, add or include the first content 150 in the set of content 150 associated with the segment 160.

A label component 340 labels one or more users 110 associated with the set of content 150 to generate a first seeded user 342 and/or second seeded user 344 based on a correlation between the users 110 and the set of content 150. The label component 340 may communicate with the content server 270 (e.g., via the network 180) to identify the one or more users 110 associated with the set of content 150. For example, the label component 340 may communicate with the content server 270 to access one or more content logs 275 at the content server 270 and, from the content logs 275, extract or identify data that identifies one or more users 110 who have been presented the content and/or one or more user devices 120 that have presented the content 150 (e.g., an impression).

Additionally, the label component 340 may extract or identify, from the content logs 275, a user metric 346 that is indicative of a correlation between the user 110 and the content 150 (e.g., a user interaction with the content 150, such as a click or conversion). In some examples, the label component 340 generates a first seeded user 342 (e.g., positive seeded user) and/or a second seeded user 344 (e.g., a negative seeded user) based on the user metric 346. For example, if a user metric 346 (e.g., quantity of clicks) associated with a user 110 satisfies a predetermined threshold, the label component 340 generates a first seeded user 342. On the other hand, if the metric does not satisfy a predetermined threshold, the label component 340 generates a second seeded user 344. That is, a user 110 who is responsive to the content 150 may be labeled as a positive seeded user, and a user 110 who is not responsive to the content 150 may be labeled as a negative seeded user.

In some examples, the predetermined threshold used to generate the first seeded user 342 is the same as the predetermined threshold used to generate the second seeded user 344 (e.g., a binary or binomial classification). Alternatively, in at least some examples, a first predetermined threshold may be used to generate the first seeded user 342, and a second predetermined threshold different from the first predetermined threshold may be used to generate the second seeded user 344. In such examples, the label component 340 may generate a third seeded user (e.g., a neutral seeded user) if the user metric 346 does not satisfy the first predetermined threshold and satisfies the second predetermined threshold.

The first seeded user 342 and/or second seeded user 344 may be used to seed the model component 285 to adapt with changes to the segment 160. For example, segment definitions may be maintained and/or updated based on adaptive seeded user labeling (e.g., first seeded user 342, second seeded user 344). The model component 285 is generated, maintained, and/or updated based on adaptive seeded user labeling such that the model server 280 is configured to automatically select and/or identify targeted content 150 for one or more users 110 associated with a segment 160.

At least some operations associated with the content component 330 and/or the label component 340 may be iteratively implemented, on a regular or irregular basis, such that a segment definition reflects recent trends in user interactions with content 150. By keeping up with segment definitions, the server environment 300 may be maintained and/or updated to automatically select and/or identify targeted content 150 that is relevant to the segment 160.

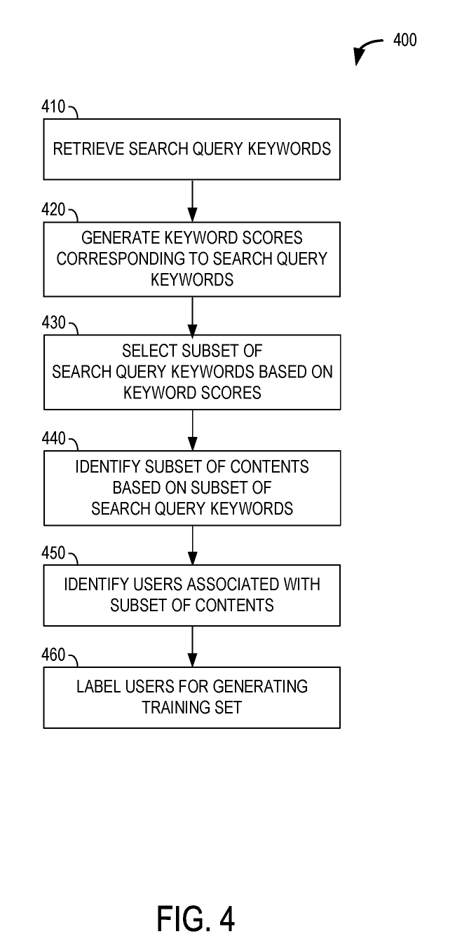

FIG. 4 is a flowchart of an example method 400 for generating, maintaining, or updating a model component 285 (shown in FIG. 2) in the environment 100 (shown in FIG. 1). In some examples, one or more search query keywords 255 associated with accessing one or more webpages 215 associated with a segment 160 are retrieved at 410. For each retrieved search query word 255, a keyword score 325 is generated at 420. The keyword scores 325 may be indicative of, for example, a correlation between the search query keywords 255 and the webpages 215 associated with the segment 160.

Based on the generated keyword scores 325, a subset 322 of search query keywords 255 is selected at 430 from the search query keywords 255 associated with accessing the webpages 215 associated with the segment 160. The subset 322 of search query keywords 255 may be selected to represent and at least partially define the segment 160. For example, the subset 322 of search query keywords 255 may be associated with keyword scores 325 that are indicative of a relatively strong correlation with the webpages 215.

Based on the subset 322 of search query keywords 255, a subset of content 150 associated with the segment 160 is identified at 440 from a plurality of content 150. For example, the subset 322 of search query keywords 255 may be compared with one or more content keywords 332 associated with content 150 to determine whether to add or include the content 150 in the subset of content 150 associated with the segment 160. One or more users 110 associated with the subset of content 150 are identified at 450. For example, the users 110 may have been presented at least one content 150 included in the subset of content 150 at a user device 120. Based on one or more user metrics 346 corresponding to a user 110 associated with the subset of content 150, the user 110 is labeled at 460 for generating a training set (e.g., model component 285) associated with the segment 160.

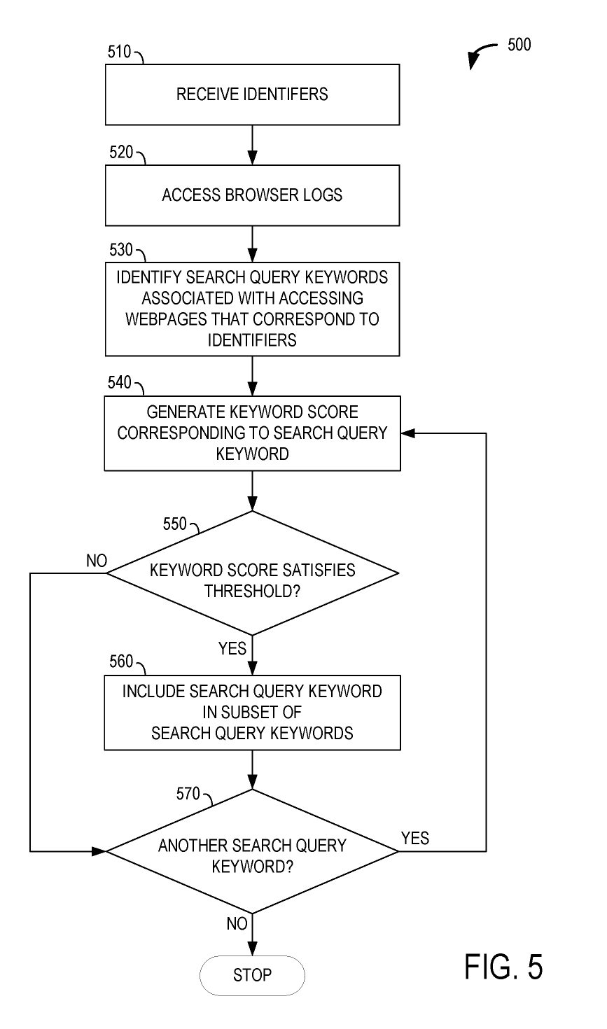

FIG. 5 is a detailed flowchart of an example method 500 for identifying a set of search query keywords 255 associated with a segment 160. In some examples, a segment 160 is associated with seeded information that potentially defines the segment 160. The seeded information may include, for example, a list of seeded identifiers 225 that correspond to one or more webpages 215 associated with the segment 160. The seeded identifiers 225 are received at 510 and, based on the seeded identifiers 225, a plurality of search query keywords 255 associated with accessing the webpages 215 associated with the segment 160 may be retrieved. In some examples, one or more browser logs 230 are accessed at 520, and the plurality of search query keywords 255 are identified at 530 based on the browser logs 230. For example, one or more browser logs 230 may be aggregated at a server (e.g., model server 280) to facilitate identifying one or more search query keywords 255.

At 540, a first keyword score 325 is generated for a first search query keyword 255 of the plurality of search query keywords 255. It is determined at 550 whether the first keyword score 325 satisfies a predetermined threshold. If the first keyword score 325 satisfies the predetermined threshold, the first search query keyword 255 corresponding to the first keyword score 325 is included at 560 in a subset 322 of search query keywords 255. If, on the other hand, the first keyword score 325 does not satisfy the predetermined threshold, the first search query keyword 255 is not included in the subset 322 of search query keywords 255.

Upon considering the first search query keyword 255 for inclusion into the subset 322 of search query keywords 255, it is determined at 570 whether another search query keyword 255 is to be considered for inclusion into the subset 322 of search query keywords 255. The process may be repeated until each search query keyword 255 in the plurality of search query keywords 255 has been considered. In some examples, the process may be repeated until the subset 322 of search query keywords 255 includes a predetermined quantity of search query keywords 255.

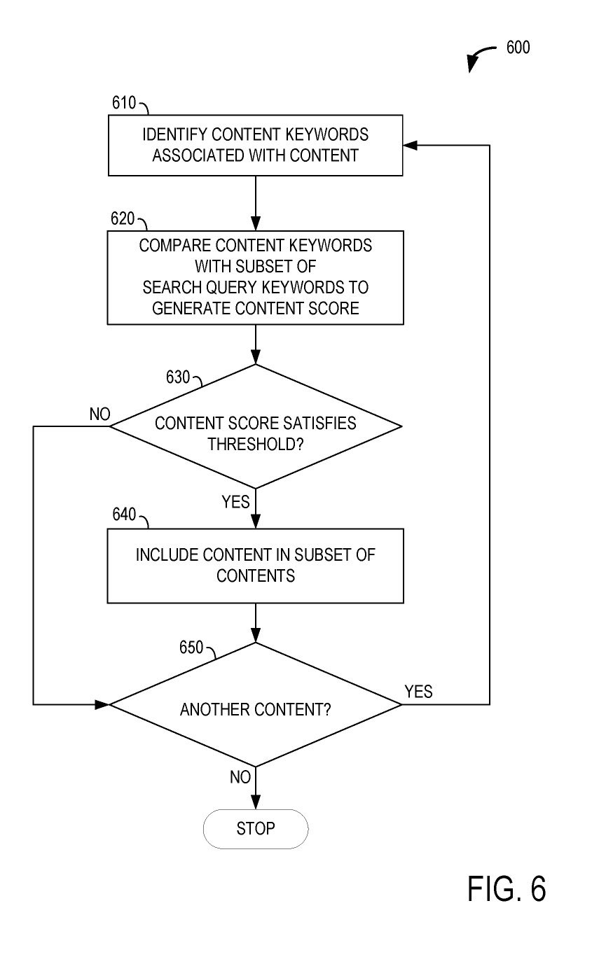

FIG. 6 is a detailed flowchart of an example method 600 for identifying a subset of content 150 associated with a segment 160. At 610, one or more content keywords 332 associated with first content 150 are identified. The content keywords 332 are compared at 620 with a subset 322 of search query keywords 255 associated with the segment 160 to generate a first content score 334 that corresponds to the first content 150. It is determined at 630 whether the first content score 334 satisfies a predetermined threshold. If the first content score 334 satisfies the predetermined threshold, the first content 150 corresponding to the first content score 334 is included at 640 in the subset of content 150. If, on the other hand, the first content score 334 does not satisfy the predetermined threshold, the first content 150 is not included in the subset of content 150. Upon considering the first content 150 for inclusion into the subset of content 150, it is determined at 650 whether another content 150 is to be considered for inclusion into the subset of content 150. The process may be repeated until each content 150 has been considered. In some examples, the process may be repeated until the subset of content 150 includes a predetermined quantity of content 150.

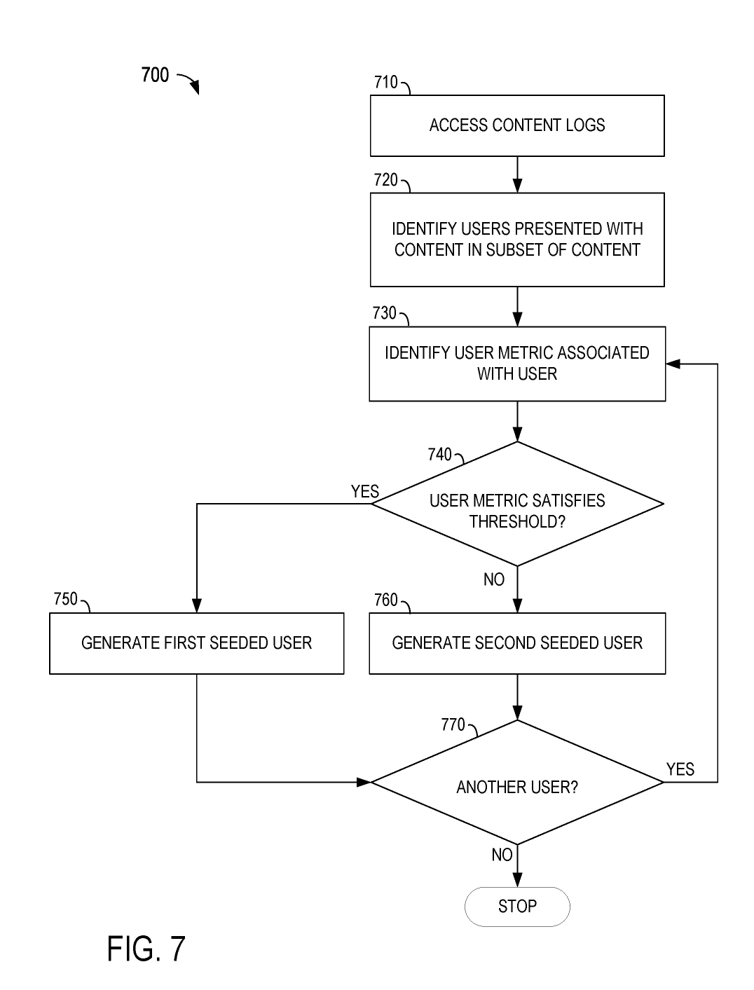

FIG. 7 is a detailed flowchart of an example method 700 for generating a first seeded user 342 and/or second seeded user 344 to seed a model component 285 associated with a segment 160. In some examples, one or more content logs 275 are accessed at 710. Based on the accessed content logs 275, one or more users 110 presented with at least one content 150 in the subset of content 150 are identified at 720. For example, one or more content logs 275 may be analyzed to determine whether a first content 150 of the subset of content 150 has been presented to a user 110. If the first content 150 has been presented to a user 110, the user 110 is included in the one or more users 110.

In some examples, the content logs 275 include one or more user metrics 346 associated with the one or more users 110. The user metrics 346 are identified at 730, and it is determined at 740 whether a user metric 346 associated with a user 110 satisfies a predetermined threshold. If the user metric 346 satisfies the predetermined threshold, the user 110 is labeled at 750 as a first seeded user 342. On the other hand, if the user metric 346 does not satisfy the predetermined threshold, the user 110 is labeled at 760 as a second seeded user 344. Upon labeling the user 110, it is determined at 770 whether another user 110 is to be labeled. The process may be repeated until each user 110 presented with at least one content 150 in the subset of content 150 has been considered. In some examples, the process may be repeated until the model component 285 has been seeded with a predetermined quantity of seeded users.

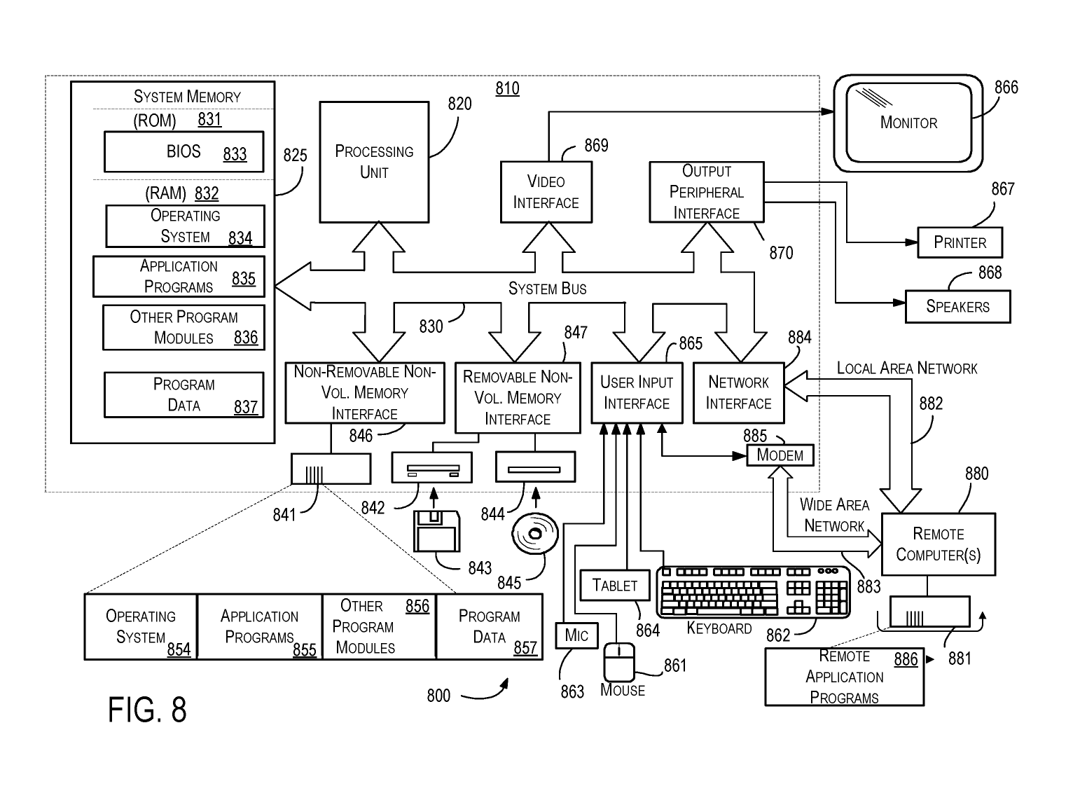

FIG. 8 is a block diagram of an example computing device 800 that may be used to generate, maintain, or update a model component 285 in the environment 100 (shown in FIG. 1). The computing device 800 is only one example of a computing and networking environment and is not intended to suggest any limitation as to the scope of use or functionality of the disclosure. The computing device 800 should not be interpreted as having any dependency or requirement relating to any one or combination of components illustrated in the example computing device 800.

The disclosure is operational with numerous other computing and networking environments or configurations. While some examples of the disclosure are illustrated and described herein with reference to the computing device 800 being or including a model server 280 (shown in FIG. 2) or a server environment 300 (shown in FIG. 3), aspects of the disclosure are operable with any computing device (e.g., user device 120, content provider device 140, content server 170, web server 210, search engine server 240, content server 270, model server 280) that executes instructions to implement the operations and functionality associated with the computing device 800.

For example, the computing device 800 may include a mobile device, a mobile telephone, a phablet, a tablet, a portable media player, a netbook, a laptop, a desktop computer, a personal computer, a server computer, a computing pad, a kiosk, a tabletop device, an industrial control device, multiprocessor systems, microprocessor-based systems, set top boxes, programmable consumer electronics, network computers, minicomputers, mainframe computers, distributed computing environments that include any of the above systems or devices, and the like. The computing device 800 may represent a group of processing units or other computing devices. Additionally, any computing device described herein may be configured to perform any operation described herein including one or more operations described herein as being performed by another computing device.

With reference to FIG. 8, an example system for implementing various aspects of the disclosure may include a general purpose computing device in the form of a computer 810. Components of the computer 810 may include, but are not limited to, a processing unit 820, a system memory 825, and a system bus 830 that couples various system components including the system memory 825 to the processing unit 820. The system bus 830 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory 825 includes any quantity of media associated with or accessible by the processing unit 820. For example, the system memory 825 may include computer storage media in the form of volatile and/or nonvolatile memory such as read only memory (ROM) 831 and random access memory (RAM) 832. The ROM 831 may store a basic input/output system 833 (BIOS) that facilitates transferring information between elements within computer 810, such as during start-up. The RAM 832 may contain data and/or program modules that are immediately accessible to and/or presently being operated on by processing unit 820. For example, the system memory 825 may store computer-executable instructions, content, media, user information, log information, scoring information, and other data.

The processing unit 820 may be programmed to execute the computer-executable instructions for implementing aspects of the disclosure, such as those illustrated in the figures (e.g., FIGS. 4-7). By way of example, and not limitation, FIG. 8 illustrates operating system 834, application programs 835, other program modules 836, and program data 837. The processing unit 820 includes any quantity of processing units, and the instructions may be performed by the processing unit 820 or by multiple processors within the computing device 800 or performed by a processor external to the computing device 800.

The system memory 825 may include a model component 285 (shown in FIG. 2), a seed component 310 (shown in FIG. 3), a keyword component 320 (shown in FIG. 3), a content component 330 (shown in FIG. 3), and/or a label component 340 (shown in FIG. 3). Upon programming or execution of these components, the computing device 800 and/or processing unit 820 is transformed into a special purpose microprocessor or machine. For example, the model component 285, when executed by the processing unit 820, causes the processing unit 820 to maintain or update one or more segment definitions associated with a segment; the seed component 310, when executed by the processing unit 820, causes the processing unit 820 to retrieve one or more search query keywords associated with accessing one or more webpages; the keyword component 320, when executed by the processing unit 820, causes the processing unit 820 to generate one or more keyword scores associated with one or more search query keywords, and select a set of search query keywords from the one or more search query keywords based on the one or more keyword scores; the content component 330, when executed by the processing unit 820, causes the processing unit 820 to compare a set of search query keywords with one or more content keywords associated with one or more content to identify a set of content from the one or more content; and the label component 340, when executed by the processing unit 820, causes the processing unit 820 to label one or more users associated with a set of content.

Although the processing unit 820 is shown separate from the system memory 825, embodiments of the disclosure contemplate that the system memory 825 may be onboard the processing unit 820 such as in some embedded systems.

The computer 810 may also include other removable/non-removable, volatile/nonvolatile computer storage media. By way of example only, FIG. 8 illustrates a hard disk drive 841 that reads from or writes to non-removable, nonvolatile magnetic media, a magnetic disk drive 842 that reads from or writes to a removable, nonvolatile magnetic disk 843 (e.g., a floppy disk, a tape cassette), and an optical disk drive 844 that reads from or writes to a removable, nonvolatile optical disk 845 (e.g., a compact disc (CD), a digital versatile disc (DVD)). Other removable/non-removable, volatile/nonvolatile computer storage media that may be used in the example operating environment include, but are not limited to, flash memory cards, digital video tape, solid state RAM, solid state ROM, and the like. The hard disk drive 841 may be connected to the system bus 830 through a non-removable memory interface such as interface 846, and magnetic disk drive 842 and optical disk drive 844 may be connected to the system bus 830 by a removable memory interface, such as interface 847.

The drives and their associated computer storage media, described above and illustrated in FIG. 8, provide storage of computer-readable instructions, data structures, program modules and other data for the computer 810. In FIG. 8, for example, hard disk drive 841 is illustrated as storing operating system 854, application programs 855, other program modules 856 and program data 857. Note that these components may either be the same as or different from operating system 834, application programs 835, other program modules 836, and program data 837. Operating system 854, application programs 855, other program modules 856, and program data 857 are given different numbers herein to illustrate that, at a minimum, they are different copies.

The computer 810 includes a variety of computer-readable media. Computer-readable media may be any available media that may be accessed by the computer 810 and includes both volatile and nonvolatile media, and removable and non-removable media.

By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. ROM 831 and RAM 832 are examples of computer storage media. Computer storage media are tangible and mutually exclusive to communication media. Computer storage media for purposes of this disclosure are not signals per se. Example computer storage media includes, but is not limited to, hard disks, flash drives, solid state memory, RAM, ROM, electrically erasable programmable read-only memory (EEPROM), flash memory or other memory technology, CDs, DVDs, or other optical disk storage, magnetic cassettes, magnetic tape, magnetic disk storage or other magnetic storage devices, or any other medium which may be used to store the desired information and which may accessed by the computer 810. Computer storage media are implemented in hardware and exclude carrier waves and propagated signals. Any such computer storage media may be part of computer 810.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

A user may enter commands and information into the computer 810 through one or more input devices, such as a pointing device 861 (e.g., mouse, trackball, touch pad), a keyboard 862, a microphone 863, and/or an electronic digitizer 864 (e.g., tablet). Other input devices not shown in FIG. 8 may include a joystick, a game pad, a controller, a satellite dish, a camera, a scanner, an accelerometer, or the like. These and other input devices may be coupled to the processing unit 820 through a user input interface 865 that is coupled to the system bus 830, but may be connected by other interface and bus structures, such as a parallel port, game port or a universal serial bus (USB).

Information, such as text, images, audio, video, graphics, alerts, and the like, may be presented to a user via one or more presentation devices, such as a monitor 866, a printer 867, and/or a speaker 868. Other presentation devices not shown in FIG. 8 may include a projector, a vibrating component, or the like. These and other presentation devices may be coupled to the processing unit 820 through a video interface 869 (e.g., for a monitor 866 or a projector) and/or an output peripheral interface 870 (e.g., for a printer 867, a speaker 868, and/or a vibration component) that are coupled to the system bus 830, but may be connected by other interface and bus structures, such as a parallel port, game port or a USB. In some examples, the presentation device is integrated with an input device configured to receive information from the user (e.g., a capacitive touch-screen panel, a controller including a vibrating component). Note that the monitor 866 and/or touch screen panel may be physically coupled to a housing in which the computer 810 is incorporated, such as in a tablet-type personal computer.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include one or more local area networks (LAN) 882 and one or more wide area networks (WAN) 883, but may also include other networks. Such networking environments are commonplace in offices, enterprise-wide computer networks, intranets and the Internet.

When used in a LAN networking environment, the computer 810 is coupled to the LAN 882 through a network interface or adapter 884. When used in a WAN networking environment, the computer 810 may include a modem 885 or other means for establishing communications over the WAN 883, such as the Internet. The modem 885, which may be internal or external, may be connected to the system bus 830 via the user input interface 865 or other appropriate mechanism. A wireless networking component such as comprising an interface and antenna may be coupled through a suitable device such as an access point or peer computer to a LAN 882 or WAN 883. In a networked environment, program modules depicted relative to the computer 810, or portions thereof, may be stored in the remote memory storage device. By way of example, and not limitation, FIG. 8 illustrates remote application programs 886 as residing on memory storage device 881. It may be appreciated that the network connections shown are examples and other means of establishing a communications link between the computers may be used.

The block diagram of FIG. 8 is merely illustrative of an example system that may be used in connection with one or more examples of the disclosure and is not intended to be limiting in any way. Further, peripherals or components of the computing devices known in the art are not shown, but are operable with aspects of the disclosure. At least a portion of the functionality of the various elements in FIG. 8 may be performed by other elements in FIG. 8, or an entity (e.g., processor, web service, server, applications, computing device, etc.) not shown in FIG. 8.

The subject matter described herein enables a computing device to automatically create a predictive model for a segment that is initially represented by a small set of seeded information. The predictive model may be automatically trained (and retrained) from the small set of seeded information, and a segment definition may be automatically augmented from data included in browser logs and/or content logs. For example, data may be extracted from the browser logs and/or the content logs to identify one or more users associated with relevant content, and the users may be automatically labeled to generate seeded information for generating, maintaining, and/or updating a machine learning model configured to identify relevant content. In this manner, the computing device may be configured to adapt a segment definition to recent trends in a calculated and systematic manner for increased performance.

Although described in connection with an example computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. Examples of the disclosure may also be practiced in distributed computing environments where tasks are performed by remote processing devices that are linked through a communications network. In a distributed computing environment, program modules may be located in local and/or remote computer storage media including memory storage devices.

The examples illustrated and described herein as well as examples not specifically described herein but within the scope of aspects of the disclosure constitute example means for providing content, and examples means for generating, maintaining, and/or updating a machine learning model for identifying content. For example, the elements illustrated in FIGS. 1, 2, 3, and/or 8, such as when encoded to perform the operations illustrated in FIGS. 4-7 constitute at least an example means for retrieving a plurality of search query keywords; an example means for generating a plurality of keyword scores; an example means for selecting a subset of search query keywords from a plurality of search query keywords; an example means for comparing a subset of search query keywords with one or more content keywords to determine whether to include content in a subset of content; an example means for identifying one or more users associated with a subset of content; and an example means for labeling one or more users for generating a training set.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

Alternatively or in addition to the other examples described herein, examples include any combination of the following:
receiving one or more identifiers corresponding to one or more webpages;
retrieving a plurality of search query keywords associated with accessing one or more webpages;
accessing one or more browser logs;
identifying a plurality of search query keywords associated with accessing one or more webpages;
generating a plurality of keyword scores corresponding to a plurality of search query keywords;
generating a keyword score associated with a search query keyword;
determining whether a keyword score satisfies a predetermined threshold;
including a search query keyword in a subset of search query keywords;
selecting a subset of search query keywords from a plurality of search query keywords;
identifying a set of search query keywords associated with a segment;
comparing a subset of search query keywords with one or more content keywords associated with a content to determine whether to include the content in a subset of content associated with a segment;
comparing a set of search query keywords with one or more content keywords associated with one or more content to identify a set of content associated with a segment;
generating a content score corresponding to a content;
determining whether a content score satisfies a predetermined threshold;
including a content in a subset of content associated with a segment;
identifying one or more users associated with a subset of content;
accessing one or more content logs;
determining whether a content of a subset of content has been presented to a user;
including a user in one or more users;
identifying a correlation between a set of content and one or more users;
labeling one or more users for generating a training set associated with a segment;
labeling one or more users to generate a training set configured to identify targeted content associated with a segment;
labeling a user of one or more users as a first seeded user;
labeling a user of one or more users as a second seeded user;
a seed component configured to retrieve one or more search query keywords associated with accessing one or more webpages;
a keyword component configured to generate one or more keyword scores corresponding to the one or more search query keywords;
a keyword component configured to select a set of search query keywords from one or more search query keywords;
a content component configured to compare a set of search query keywords with one or more content keywords associated with one or more content to identify a set of content from one or more content; and
a label component configured to label one or more users associated with a set of content based on a correlation between one or more users and the set of content.

In some examples, the operations illustrated in the drawings may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

What is claimed is:

1. A computer-implemented method comprising:
retrieving a plurality of search query keywords associated with accessing one or more webpages, the one or more webpages associated with a segment;
generating, at a computing device, a plurality of keyword scores corresponding to the retrieved plurality of search query keywords, the plurality of keyword scores indicative of a correlation between the plurality of search query keywords and the one or more webpages;
based on the generated plurality of keyword scores, selecting a subset of search query keywords from the plurality of search query keywords, the selected subset of search query keywords identified as being associated with the segment;
comparing, at the computing device, the selected subset of search query keywords with one or more content keywords associated with a content;
based on the comparison, including the content in a subset of content associated with the segment;
identifying one or more users associated with the subset of content, the identified one or more users associated with one or more metrics; and
based on the one or more metrics, labeling, at the computing device, the identified one or more users for generating a training set associated with the segment.

2. The method of claim 1, further comprising receiving one or more identifiers corresponding to the one or more webpages, wherein the plurality of search query keywords are retrieved based on the received one or more identifiers.

3. The method of claim 1, wherein retrieving the plurality of search query keywords comprises:
accessing one or more browser logs; and
based on the accessed one or more browser logs, identifying the plurality of search query keywords associated with accessing the one or more webpages.

4. The method of claim 1, wherein
generating the plurality of keyword scores comprises generating a first keyword score associated with a first search query keyword of the plurality of search query keywords; and
selecting the subset of search query keywords comprises:
determining whether the generated first keyword score satisfies a predetermined threshold, and
on condition that the generated first keyword score satisfies the predetermined threshold, including the first search query keyword in the subset of search query keywords.

5. The method of claim 1, wherein comparing the selected subset of search query keywords with the one or more content keywords associated with the content comprises:
based on the subset of search query keywords and the one or more content keywords, generating a content score corresponding to the content;
determining whether the generated content score satisfies a predetermined threshold; and
on condition that the generated content score satisfies the predetermined threshold, including the content in the subset of content associated with the segment.

6. The method of claim 1, wherein identifying the one or more users comprises:
accessing one or more content logs;
based on the accessed one or more content logs, determining whether a first content of the subset of content has been presented to a first user; and
on condition that the first content of the subset of content has been presented to the first user, including the first user in the one or more users.

7. The method of claim 1, wherein labeling the identified one or more users comprises:
on condition a first metric of the one or more metrics satisfies a predetermined threshold, labeling a first user of the one or more users as a first seeded user; and
on condition the first metric does not satisfy the predetermined threshold, labeling the first user as a second seeded user, the labeled first user corresponding to the first metric.

8. A computing device comprising:
a memory device that stores data associated with one or more model components and computer-executable instructions, the one or more model components associated with one or more segments; and
a processor that executes the computer-executable instructions to:
retrieve one or more search query keywords associated with accessing one or more webpages, the one or more webpages associated with a segment of the one or more segments;
based on a first correlation between the retrieved one or more search query keywords and the one or more webpages, generate one or more keyword scores corresponding to the one or more search query keywords;
based on the generated one or more keyword scores, identify a set of search query keywords associated with the segment;
compare the identified set of search query keywords with one or more content keywords associated with one or more content to identify a set of content associated with the segment; and
based on a second correlation between the identified set of content and one or more users associated with the set of content, label the one or more users to generate a training set configured to identify targeted content associated with the segment.

9. The computing device of claim 8, wherein the processor is configured to execute the computer-executable instructions to receive one or more identifiers corresponding to the one or more webpages, wherein the one or more search query keywords are retrieved based on the received one or more identifiers.

10. The computing device of claim 8, wherein the processor is configured to execute the computer-executable instructions to:
access one or more browser logs; and
based on the accessed one or more browser logs, identify the one or more search query keywords associated with accessing the one or more webpages.

11. The computing device of claim 8, wherein the processor is configured to execute the computer-executable instructions to:
generate a first keyword score of the one or more keyword scores, the first keyword score associated with a first search query keyword of the one or more search query keywords; and
on condition that the generated first keyword score satisfies a predetermined threshold, include the first search query keyword in the set of search query keywords.

12. The computing device of claim 8, wherein the processor is configured to execute the computer-executable instructions to:
based on the set of search query keywords and a first content keyword of the one or more content keywords, generate a content score corresponding to a first content of the one or more content, the first content keyword associated with the first content; and
on condition that the generated content score satisfies a predetermined threshold, including the first content in the set of content associated with the segment.

13. The computing device of claim 8, wherein the processor is configured to execute the computer-executable instructions to:
access one or more content logs; and
based on the accessed one or more content logs, identify the second correlation between the identified set of content and the one or more users.

14. The computing device of claim 8, wherein the processor is configured to execute the computer-executable instructions to:
label a first user of the one or more users as a first seeded user, the first user associated with a first metric that satisfies a predetermined threshold; and
label a second user of the one or more users as a second seeded user, the second user associated with a second metric that does not satisfy the predetermined threshold.

15. A system comprising:
a seed component that retrieves one or more search query keywords associated with accessing one or more webpages, the one or more webpages associated with a segment;
a keyword component that generates one or more keyword scores corresponding to the one or more search query keywords, and selects a set of search query keywords from the one or more search query keywords based on the one or more keyword scores, the one or more keyword scores indicative of a correlation between the one or more search query keywords and the one or more webpages, the set of search query keywords associated with the segment;
a content component that compares the set of search query keywords with one or more content keywords associated with one or more content to identify a set of content from the one or more content, the set of content associated with the segment; and
a label component that labels one or more users associated with the set of content based on a correlation between the one or more users and the set of content, the one or more users labeled to seed a training set associated with the segment.

16. The system of claim 15, wherein the seed component is configured to:
access one or more browser logs; and
based on the accessed one or more browser logs, identify the one or more search query keywords associated with accessing the one or more webpages.

17. The system of claim 15, wherein the keyword component is configured to:
generate a first keyword score of the one or more keyword scores, the first keyword score associated with a first search query keyword of the one or more search query keywords; and
on condition that the generated first keyword score satisfies a predetermined threshold, include the first search query keyword in the set of search query keywords.

18. The system of claim 15, wherein the content component is configured to:
generate a content score corresponding to a first content of the one or more content based on a correlation between the set of search query keywords and a first content keyword of the one or more content keywords; and
on condition that the generated content score satisfies a predetermined threshold, including the first content in the set of content associated with the segment.

19. The system of claim 15, wherein the label component is configured to:
access one or more content logs;
based on the accessed one or more content logs, determine whether a first content of the set of content has been presented to a first user; and
on condition that the first content of the set of content has been presented to the first user, including the first user in the one or more users.

20. The system of claim 15, wherein the label component is configured to:
label a first user of the one or more users as a first seeded user, the first user associated with a first metric that satisfies a predetermined threshold; and
label a second user of the one or more users as a second seeded user, the second user associated with a second metric that does not satisfy the predetermined threshold.
